(19) United States
(12) Patent Application Publication
(10) Pub. No.: US 2026/0018174 A1
(43) Pub. Date: Jan. 15, 2026

(54) INFORMATION CONVERSION SYSTEM, INFORMATION PROCESSING APPARATUS, INFORMATION PROCESSING METHOD, INFORMATION CONVERSION METHOD, AND STORAGE MEDIUM

(71) Applicant: CANON KABUSHIKI KAISHA, Tokyo (JP)

(72) Inventors: TAKESHI KONDOH, Tokyo (JP); TAIHEI MUKAIDE, Kanagawa (JP)

(21) Appl. No.: 19/337,335

(22) Filed: Sep. 23, 2025

Related U.S. Application Data
(63) Continuation of application No. PCT/JP2024/009264, filed on Mar. 11, 2024.

(30) Foreign Application Priority Data
Mar. 27, 2023 (JP) 2023-050406
Feb. 29, 2024 (JP) 2024-030010

(51) Int. Cl. G10L 15/25; G10L 15/06; G10L 15/16; G10L 25/18; G10L 25/21

(52) U.S. Cl. CPC G10L 15/25; G10L 15/063; G10L 15/16; G10L 25/18; G10L 25/21

(57) ABSTRACT

An information conversion system including a biological information acquisition unit configured to acquire biological information based on a muscle movement caused by a speech motion of a user, a conversion unit configured to convert the biological information into text information by using the biological information to acquire feature matrix data based on an acquisition time of the biological information and inputting the feature matrix data to an inference model to cause the inference model to infer the text information corresponding to the feature matrix data, and an output unit configured to output the text information converted by the conversion unit.

### CROSS-REFERENCE TO RELATED APPLICATIONS

This application is a Continuation of International Patent Application No. PCT/JP2024/009264, filed Mar. 11, 2024, which claims the benefit of Japanese Patent Applications No. 2023-050406, filed Mar. 27, 2023, and No. 2024-030010, filed Feb. 29, 2024, all of which are hereunder incorporated by reference herein in their entirety.

### BACKGROUND

### Field of the Technology

The present disclosure relates to an information conversion system, an information processing apparatus, an information processing method, an information conversion method, and a storage medium for converting biological information based on a muscle movement caused by a speech motion of a user into text information.

### Description of the Related Art

In recent years, speech content has been estimated from mouth movements of a user. Japanese Patent Laid-Open No. 1995-181888 describes a technology for converting myoelectric potential signals acquired from a periphery of the mouth and the pharyngeal part of a laryngectomized person who has lost the larynx, into power spectra, inputting the power spectra to a neural network, recognizing syllables, and outputting synthesized speech.

However, in Japanese Patent Laid-Open No. 1995-181888, because an input to the neural network is a power spectrum obtained by converting a myoelectric potential signal, and further, an output is configured with a syllable composed of a single phoneme, the accuracy may be insufficient in some cases.

### SUMMARY

The present disclosure is directed to providing an information conversion system an information processing apparatus, an information processing method, an information conversion method, and a storage medium, using an inference model for inferring feature matrix data corresponding to a plurality of syllables to infer text information with high accuracy from biological information based on a muscle movement caused by a speech motion of a user.

An information conversion system including a biological information acquisition unit configured to acquire biological information based on a muscle movement caused by a speech motion of a user, a conversion unit configured to convert the biological information into text information by using the biological information to acquire feature matrix data based on an acquisition time of the biological information and inputting the feature matrix data to an inference model to cause the inference model to infer the text information corresponding to the feature matrix data, and an output unit configured to output the text information converted by the conversion unit.

Features of the present disclosure will become apparent from the following description of embodiments with reference to the attached drawings.

### BRIEF DESCRIPTION OF THE DRAWINGS

FIG. 1 is a diagram illustrating an example of a functional configuration of an information conversion system of the present disclosure.

FIG. 2 is a diagram illustrating an example of a functional configuration of a conversion unit of the present disclosure.

FIG. 3 is a flowchart illustrating conversion processing of the information conversion system of the present disclosure.

FIG. 4 is a diagram illustrating a preprocessing unit in the conversion unit of the present disclosure.

FIG. 5 is a diagram illustrating an example of a functional configuration of a training unit of the present disclosure.

FIG. 6 is a flowchart illustrating training processing by the training unit of the present disclosure.

FIG. 7 is a schematic diagram illustrating a detection device according to a first example of the present disclosure.

FIG. 8 is a diagram illustrating an operation of the conversion unit according to the first example of the present disclosure.

FIG. 9 is a schematic diagram of a detection device of a third modification of the present disclosure.

### DESCRIPTION OF THE EMBODIMENTS

An information conversion system according to the present disclosure is an information conversion system that converts biological information based on a muscle movement caused by a speech motion of a user into text information with high accuracy.

Hereinafter, a configuration for acquiring information that has been detected from predetermined sensor information as an example of the biological information will be described, but the information is not limited to information obtained by the sensor described below. By additionally inputting known information, such as speech data and image data, to other channels of input data that is input to an inference model, inference can be performed with higher accuracy.

Hereinafter, an example of an embodiment of the present disclosure will be described with reference to the drawings.

### First Embodiment

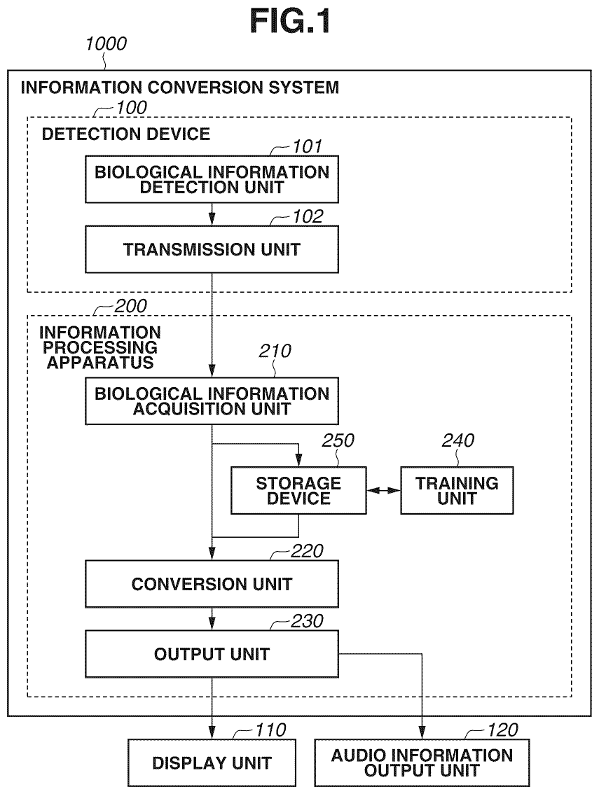

An outline of an information conversion system 1000 of the present disclosure is described with reference to FIG. 1. The information conversion system 1000 includes a detection device 100 that detects biological information based on a muscle movement caused by a speech motion of a user, and an information processing apparatus 200 that acquires the detected biological information and converts the biological information into text information using an inference model. The detection device 100 and the information processing apparatus 200 may be configured as separate apparatuses with a network connecting each other, or may be configured as an integrated apparatus.

### <Detection Device 100>

The detection device 100 included in the information conversion system 1000 is configured to include a biological information detection unit 101 that detects biological information from one or more parts of the user, and a transmission unit 102 that transmits the biological information detected by the biological information detection unit 101 to the information processing apparatus 200.

The detection device 100 is placed to be in contact with the user's skin, for example, to acquire biological information from the user. The detection device 100 is desirably placed in a part, such as the neck, the lower jaw, in the proximity of the mouth, or the temple, to detect biological information based on a muscle movement caused by a speech motion of the user. The detection device 100 may be placed at a part other than the above-described parts as long as the part is a position where biological information regarding a movement of the mouth or the tongue can be detected.

Although FIG. 1 illustrates a form in which the detection device 100 is implemented as a single device, the biological information detection unit 101 and the transmission unit 102 may be configured as separate devices. Hereinbelow, each functional configuration included in the detection device 100 will be described.

The biological information detection unit 101 is configured to include a sensor for detecting biological information based on a muscle movement of the user. The biological information detection unit 101 includes at least one sensor, such as a myoelectric potential sensor, an acceleration sensor, an ultrasonic sensor, a tactile sensor, an optical sensor, a pressure sensor, or a strain sensor. The biological information detection unit 101 may include a sensor other than the above-listed sensor as long as the sensor detects biological information.

The transmission unit 102 transmits biological information based on a muscle movement caused by a speech motion of the user, which has been acquired from the biological information detection unit 101, to the information processing apparatus 200.

### <Information Processing Apparatus 200>

In the present embodiment, the information processing apparatus 200 included in the information conversion system 1000 includes a biological information acquisition unit 210 that acquires the biological information transmitted from the detection device 100, a conversion unit 220 that acquires feature matrix data based on an acquisition time of the biological information by using the biological information and converts the biological information into text information by inputting the feature matrix data into an inference model to cause the inference model to infer text information corresponding to the feature matrix data, and an output unit 230 that outputs the text information acquired by the conversion unit 220 to a display unit 110 and an audio information output unit 120.

In the present embodiment, the inference model is a trained inference model that has been trained by a training unit 240 and stored in a storage device 250. The training unit 240 and other functional configurations may be separately configured as independent devices. For example, the training unit 240 may perform training of the inference model to be used for inference in the conversion unit 220 in the cloud.

In the present embodiment, the information processing apparatus 200 may be a smartphone, a personal computer (PC), a tablet PC, or the like, and is configured to include a central processing unit (CPU), a graphics processing unit (GPU), a random access memory (RAM), a read-only memory (ROM), and a storage apparatus, and is implemented by connecting these components via a system bus. In a case where the information processing apparatus 200 is, for example, a personal computer, the text information, which has been converted from the biological information based on a muscle movement caused by a speech motion of the user by the conversion unit 220, is output to the display unit 110, such as a display, by the output unit 230, and in a case where the text information is converted into audio information, the audio information is output to the audio information output unit 120, such as a speaker. The audio information output unit 120 may be incorporated in the apparatus configuration of the information processing apparatus 200.

In the present embodiment, communication between the detection device 100 and the information processing apparatus 200 may be wired or wireless. In a case where the communication between the detection device 100 and the information processing apparatus 200 is implemented via a wired connection, the transmission unit 102 in the detection device 100 and the biological information acquisition unit 210 in the information processing apparatus 200 are connected via a wired connection, such as a universal serial bus (USB) cable or a high-definition multimedia interface HDMI® cable.

In a case where the communication between the detection device 100 and the information processing apparatus 200 is implemented wirelessly, the transmission unit 102 in the detection device 100 and the biological information acquisition unit 210 in the information processing apparatus 200 are wirelessly connected to each other by communication of a wireless local area network (LAN), such as Wi-Fi®, or short-range wireless communication, such as Bluetooth® or the like. In a case where the information processing apparatus 200 is a smartphone or a tablet PC, the display unit 110 is a display. The audio information output unit 120 is a speaker installed in the smartphone or the tablet PC, or an earphone connected to the smartphone or the tablet PC.

Hereinafter, each functional configuration included in the information processing apparatus 200 will be described.

The biological information acquisition unit 210 acquires the biological information based on the muscle movement caused by the speech motion of the user, which has been transmitted from the detection device 100. In the present embodiment, the transmitted biological information is at least one of myoelectric potential information, acceleration information, angular velocity information, and magnetic information based on the user's speech motion. The biological information in the present embodiment is information that does not include speech information. Alternatively, in addition to the above-described biological information, speech information and image information may be further acquired in accordance with a specification of an inference model for use in conversion of the biological information by the conversion unit 220.

The biological information may be two or more types of information acquired from one part where the detection device 100 is placed on the user. Although the details will be described below, for example, the detection device 100 is configured to include a myoelectric potential sensor, an acceleration sensor, an angular velocity sensor, and a magnetic sensor, and the biological information acquisition unit 210 acquires information on myoelectric potential, information on acceleration, and information on angular velocity. The myoelectric potential sensor is a sensor that acquires a myoelectric potential signal generated in accordance with a muscle movement. The acceleration sensor is a sensor that detects acceleration and outputs data or a signal corresponding to the detected acceleration. The angular velocity sensor (gyro sensor) is a sensor that detects an angular velocity and outputs data or a signal corresponding to the detected angular velocity. These sensors may be placed at a plurality of parts on the user. In a case of placing the sensors at a plurality of parts, a plurality of sensors may be placed in each placement part, or each placement part may be configured with only a predetermined sensor.

The conversion unit 220 acquires feature matrix data based on the acquisition time of the biological information by using the biological information transmitted from the biological information acquisition unit 210, and performs inference using the feature matrix data as an input to an inference model, whereby the biological information is converted into text information. The acquisition time of the biological information is information indicating at which timing the biological information has been acquired with respect to a time axis. The biological information is, for example, biological information corresponding to an utterance time of one phrase, and the acquisition time of the biological information serves as an index indicating in which order power spectra are to be successively arranged when feature matrix data, such as a spectrogram, is generated. The design can be configured as appropriate in accordance with a length of entire biological information in the time direction, the frame size when each power spectrum is extracted, the frame shift that defines how much the frame is to be moved, and the like.

The output unit 230 outputs the text information converted by the conversion unit 220 to the display unit 110 or the audio information output unit 120.

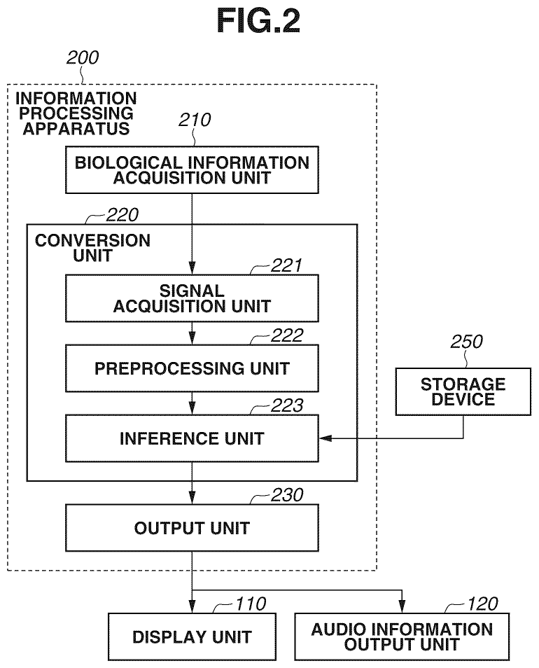

An example of the functional configuration of the conversion unit 220 will be described below with reference to FIG. 2.

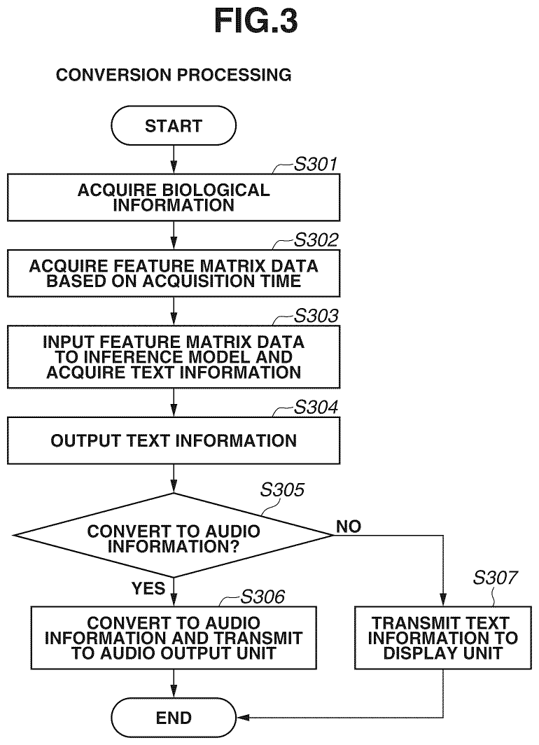

The conversion unit 220 is configured to include a signal acquisition unit 221 that acquires the biological information received by the biological information acquisition unit 210, a preprocessing unit 222 that performs preprocessing on the acquired signal, and an inference unit 223 that infers text information by using the preprocessed signal. An example of a conversion procedure in the information processing apparatus 200 will be described with reference to FIG. 3.

### (Step S301)

In step S301, the signal acquisition unit 221 in the conversion unit 220 acquires biological information, such as a myoelectric potential signal transmitted from the detection device 100. The biological information acquired in this processing is based on a muscle movement caused by a speech motion of the user, and is, for example, myoelectric potential information, acceleration information, angular velocity information, and magnetic information. After the signal acquisition unit 221 transmits the biological information to the preprocessing unit 222, the processing proceeds to the next step.

### (Step S302)

In step S302, the preprocessing unit 222 in the conversion unit 220 uses the biological information to acquires feature matrix data based on the acquisition time of the biological information.

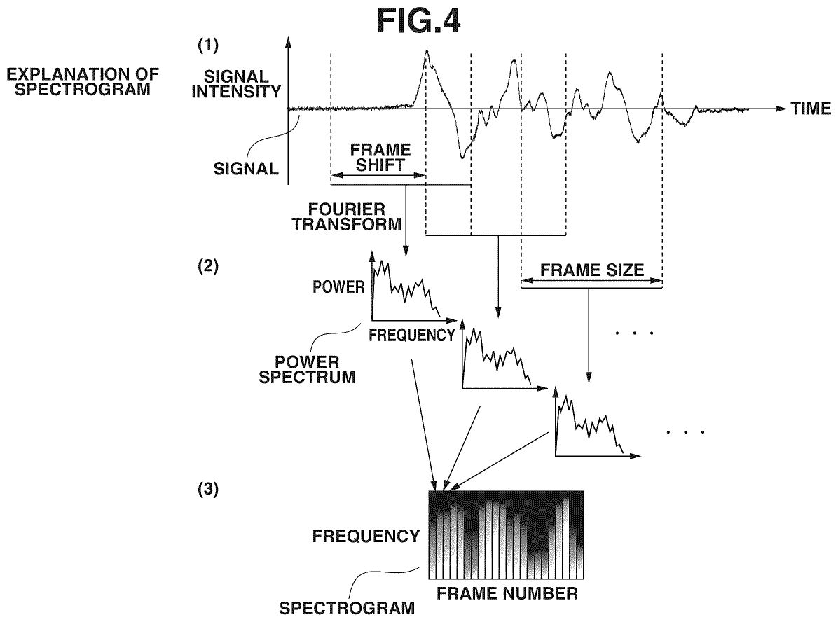

The processing will be described with reference to FIG. 4.

FIG. 4 is an explanatory diagram illustrating processing in which the preprocessing unit 222 included in the conversion unit 220 acquires a spectrogram from biological information.

The preprocessing unit 222 performs processing for extracting a signal from the acquired biological information at short time intervals (the extracted signal is referred to as a frame, and a length of the frame is referred to as a frame size). Here, each frame is extracted in such a manner that a part of each frame overlaps with adjacent frames (an interval between frames is referred to as a frame shift). The frame size and the frame shift can be set as appropriate.

Then, the preprocessing unit 222 performs Fourier transform on each frame and acquires a plurality of power spectra each corresponding to a different frame of the frames.

Finally, the preprocessing unit 222 acquires feature matrix data known as a spectrogram, by using the plurality of obtained power spectra as column vectors and successively arranging the plurality of obtained power spectra in the row direction, based on the acquisition time of the corresponding biological information.

The preprocessing unit 222 may further perform various processes on the biological information transmitted from the signal acquisition unit 221. For example, the preprocessing unit 222 may perform, on a signal serving as the biological information, preprocessing for excluding abnormal values, performing normalization processing (setting the average of the signal to 0 and the variance to 1), and calculating a moving average, and acquire the above-described feature matrix data from a result of the processing.

Alternatively, the preprocessing unit 222 may apply a window function, such as a Hamming window, to each frame that is used when short-time signals are extracted from the biological information.

The preprocessing unit 222 may use a different method with respect to the power spectrum to acquire the feature matrix data. For example, the preprocessing unit 222 may apply a filter, such as a low-pass filter, to the power spectrum, or may perform an octave analysis or a Mel filter bank analysis to convert the power spectrum into a Mel filter bank features, whereby the feature matrix data is acquired. Alternatively, the preprocessing unit 222 may perform a cepstrum analysis on the power spectrum and convert the power spectrum into a cepstrum, to acquire the feature matrix data. Feature matrix data in which column vectors obtained by any of the above-described processing are successively arranged in the row direction may be used instead of the spectrogram, or a plurality of pieces of feature matrix data may be superimposed, and the resultant data may be used as three-dimensional array data in processing described below. The preprocessing unit 222 may perform Fourier transform on each frame and acquire a plurality of Fourier spectra corresponding to the respective frames. Real parts of the plurality of obtained Fourier spectra are used as column vectors and are successively arranged in the row direction based on the acquisition time of the corresponding biological information, whereby feature matrix data is acquired. Hereinafter, the feature matrix obtained by this processing is referred to as a real part Fourier spectrogram. Similarly, imaginary parts of the plurality of obtained Fourier spectra are used as column vectors to acquire feature matrix data, and this feature matrix is referred to as an imaginary part Fourier spectrogram. Alternatively, the feature matrix data may be acquired by using absolute values of the real parts or the imaginary parts of the Fourier spectra as column vectors. Further, a three-dimensional array obtained by superimposing the real part Fourier spectra and the imaginary part Fourier spectra is referred to as a complex Fourier spectrogram. Any of the above-described feature matrix data may be used in the processing described below, or a plurality of feature matrices may be superimposed and used as three-dimensional array data in the processing described below. Alternatively, the feature matrix may be superimposed on the above-described spectrogram and/or the like to obtain three-dimensional array data for use in the processing described below.

The preprocessing unit 222 acquires feature matrix data based on the acquisition time of the biological information by using the biological information, and when the preprocessing unit 222 transmits the acquired feature matrix data to the inference unit 223, the processing proceeds to the next step.

### (Step S303)

In step S303, the inference unit 223 inputs the feature matrix data transmitted from the preprocessing unit 222 to an inference model and causes the inference model to infer text information corresponding to the feature matrix data.

Specifically, the inference unit 223 infers text information from a spectrogram, which is the feature matrix data acquired by the preprocessing unit 222.

In the present embodiment, in inference by the inference unit 223, an inference model that has been trained by an architecture configured by a neural network and is acquired from the storage device 250 is used. The trained inference model is an inference model that is configured using a network of publicly known inference models, and has been generated by applying training processing to an inference model having a network configuration of a convolutional neural network (CNN), a recurrent neural network (RNN), or a long short term memory (LSTM), which are types of deep learning, for example. The inference model that is used by the inference unit 223 in inference may be based on a model derived from CNN, RNN, or LSTM, or may use other learning techniques, such as a support vector machine, logistic regression, or a random forest, or a rule-based method.

Examples of the text information to be output as a result of the inference by the inference model in the inference unit 223 include syllables, such as [symbol]
“a”, [symbol]
“i”, [symbol]
“u”, [symbol]
“e”, [symbol]
“o”, [symbol]
“ka”, and [symbol]
“ki”, a string of syllables, such as [symbol]
“ko-n-ni-chi-wa”, meaning “hello”, and [symbol]
“o-ya-su-mi”, meaning “good night”, and a character string including kanji characters, numbers, and katakana characters, such as [symbol]
“NAISEN-5-BAN-ni-DENNWA-wo-kakete”, meaning “call extension number 5”, and [symbol]
“raito-wo-KE-shi-te”, meaning “turn off light” (uppercase letters indicate kanji and italic letters indicate katakana).

A result of the inference by the inference unit 223 may be an alphabet string, such as “k a t a z u k e t e” meaning “clean up” or “h a j i m e m a s h i t e” meaning “nice to meet you” or a mora string, such as “de N m a a k u” meaning “Denmark” or “by u cl f e n i i k u” meaning “go to a buffet”, and the language is not limited to Japanese. When the inference unit 223 transmits the text information that is the result of the inference to the output unit 230, the processing proceeds to the next step. The conversion unit 220 may further convert the text information output by the inference unit 223.

For example, the conversion unit 220 converts “k a t a z u k e t e” into [symbol]
meaning “clean up” or converts “by u cl f e n i i k u” into [symbol]
meaning “go to a buffet”, so that the user can easily understand the text information. The conversion unit 220 does not perform the conversion when conversion is not necessary to perform.

### (Step S304)

In step S304, the output unit 230 outputs the text information acquired from the conversion unit 220 to an external apparatus.

### (Step S305)

In step S305, the output unit 230 transmits the output information to the display unit 110 or the audio information output unit 120, or both the display unit 110 and the audio information output unit 120. Here, the output unit 230 determines an output destination of the text information, based on information on a connection with the external apparatus, information on a user setting for the information processing apparatus 200, or the like. For example, in a case where the information processing apparatus 200 is connected to the audio information output unit 120, and display on the display unit 110 is disabled, the output unit 230 determines that the text information is to be converted to audio information (YES in step S305), and the processing proceeds to step S306. On the other hand, in a case where the information processing apparatus 200 is connected to the display unit 110, and audio output is disabled, the output unit 230 determines that the text information is not to be converted to audio information (NO in step S305), the processing proceeds to step S307.

Alternatively, in a case where both text information and audio information can be output, both step S306 and step S307 may be performed.

### (Step S306)

In step S306, the output unit 230 further converts the text information converted by the conversion unit 220 into audio information, and transmits the audio information to the audio information output unit 120. The audio information output unit 120 is, for example, a speaker or a bone conduction earphone, and can reproduce the audio information.

### (Step S307)

In step S307, the output unit 230 transmits the text information converted by the conversion unit 220 to the display unit 110.

With this configuration, the information conversion system 1000 can convert biological information based on a muscle movement caused by a speech motion of the user into text information with high accuracy. Specifically, by inferring feature matrix data using the inference model to which the feature matrix data based on an acquisition time of the biological information can be input, inference factoring in a time-series relationship of the biological information can be performed, whereby conversion into text information with high accuracy is realized.

The following is a description of the training unit 240 for training the inference model for use in the conversion unit 220, and the storage device 250 for storing the trained inference model. The training unit 240 is not necessarily provided by the same apparatus or the same entity, and the processing of the training unit 240 may be substituted by storing a trained inference model which has been generated by a different apparatus or a different entity, in the storage device 250.

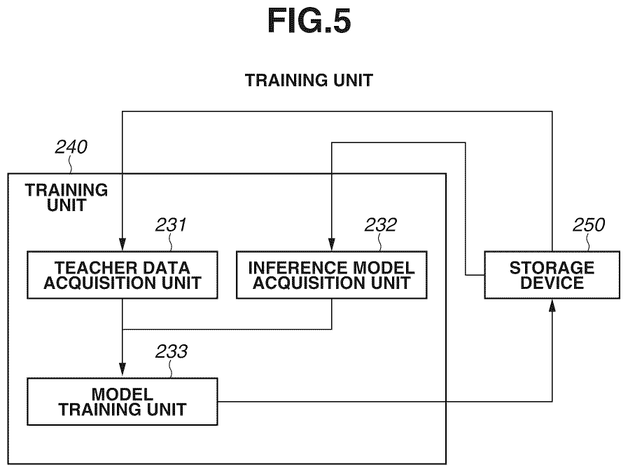

In the information processing apparatus 200, the training unit 240 performs training processing on an inference model using teacher data to generate the trained inference model. FIG. 5 is a diagram illustrating an example of a configuration of the training unit 240. The training unit 240 includes a teacher data acquisition unit 231 that acquires teacher data from biological information and the corresponding text information from the storage device 250, an inference model acquisition unit 232 that acquires an inference model as a training target from the storage device 250, and a model training unit 233 that uses the inference model and the teacher data to train the inference model.

In the present embodiment, the storage device 250 stores a large number of pieces of biological information detected by the detection device 100 and text information corresponding to the biological information, and the teacher data acquisition unit 231 uses the information as teacher data in training in which weights of the model are learned. The storage device 250 stores a model configured with an architecture including a neural network, and the weights of the model trained by the model training unit 233.

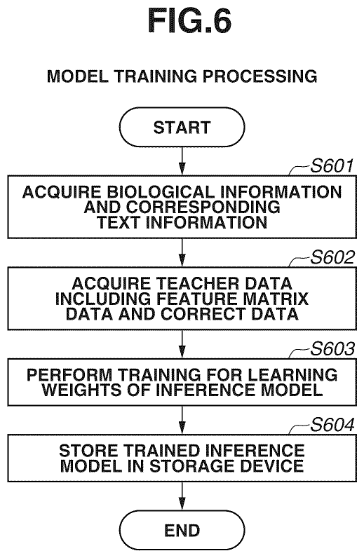

The following is a description of a training procedure of the inference model by the training unit 240 with reference to FIG. 6.

### (Step S601)

In step S601, the teacher data acquisition unit 231 acquires, from the storage device 250, biological information based on a muscle movement caused by a speech motion of the user and text information corresponding to the biological information, and the processing proceeds to step S602.

### (Step S602)

In step S602, the teacher data acquisition unit 231 acquires teacher data from the acquired biological information and text information. More specifically, the teacher data acquisition unit 231 acquires teacher data by converting the acquired biological information into feature matrix data, such as a spectrogram, in a similar manner to the preprocessing unit 222 of the conversion unit 220.

The teacher data acquisition unit 231 acquires ground truth by converting the text information corresponding to the biological information into text information suitable for training as necessary. For example, the teacher data acquisition unit 231 converts [symbol]
or [symbol]
meaning “turn off light” into “r a i t o o k e s h i t e”, or the like.

When the teacher data acquisition unit 231 transmits the teacher data to the model training unit 233, the processing proceeds to step S603.

### (Step S603)

The model training unit 233 performs the training processing on the inference model by using the teacher data transmitted from the teacher data acquisition unit 231 and the inference model transmitted from the inference model acquisition unit 232, whereby training in which weights as parameters of the inference model are learned is performed.

In other words, the model training unit 233 trains the inference model by using, as the teacher data, the feature matrix data based on an acquisition time of biological information, which has been acquired using the biological information based on a muscle movement caused by a speech motion of the user, and the text information based on speech information on the speech motion of the user.

The architecture of the inference model trained by the model training unit 233 is also used by the inference unit 223 of the conversion unit 220. The model training unit 233 uses stochastic gradient descent (SGD), adaptive moment estimation (Adam), or the like as an optimization function that is applied when training an inference model, and uses cross-entropy loss or connectionist temporal classification (CTC) loss as a loss function. The optimization function and the loss function are not limited to these, and various functions are used.

### (Step S604)

In step S604, when the training processing of the inference model is ended, the model training unit 233 stores information on the trained inference model in the storage device 250 and ends the processing. In the present embodiment, the information stored in the storage device 250 is, for example, the inference model and parameter information, such as optimized weights.

The training unit 240 may be implemented as a function on a personal computer or may be configured on a cloud. Only some of the functions, such as the model training unit 233, may be configured on the cloud.

### Second Embodiment

In a second embodiment, an information processing apparatus 200 has a plurality of inference models. In the present embodiment, a conversion unit 220 converts biological information into text information by using an inference model selected from among the plurality of inference models. In the present embodiment, an information conversion system 1000 selects a predetermined inference model from among the plurality of inference models so that conversion of biological information can be performed. The redundant descriptions of those in the first embodiment will be omitted as appropriate. In other words, the conversion unit 220 has a plurality of inference models and performs inference using a selected inference model.

Specifically, each of the plurality of inference models differs in teacher data or in an inference model architecture. The differences in teacher data indicate variations in attributes, for example, gender, age, nationality, language, and other characteristics that configure the teacher data. In general, the amount of the teacher data is considered as an important factor in determining performance of the model, but the performance of the model may be degraded if there is variation or bias in features across the data. Thus, for example, a plurality of models each having a different language is provided, and appropriate inference is performed, so that conversion into text information is able to be performed with high accuracy.

In the present embodiment, the information processing apparatus 200 includes a first trained inference model acquired by training a first inference model with first teacher data divided under a predetermined condition and a second trained inference model acquired by training a second inference model with second teacher data, and the conversion unit 220 selects an appropriate inference model from among the plurality of inference models to convert biological information into text information.

In the present embodiment, the conversion unit 220 further acquires setting information set by a user. The setting information is, for example, attribute data on the user, such as nationality and language.

In a case where Japanese is selected, the conversion unit 220 selects an inference model corresponding to Japanese and converts the feature matrix data into text information.

The selection of the inference model is not limited to the case of acquiring the setting information set by the user.

For example, a detection device 100 further includes a speech information acquisition unit, and the conversion unit 220 inputs the biological information to the plurality of inference models. The conversion unit 220 may compare text information converted from speech information on speech motion by the user with text information converted from the biological information and select a model whose matching rate satisfies a predetermined condition. Examples of the predetermined condition include a threshold comparison and an inter-model comparison, and a model with the highest accuracy is selected.

The information conversion system 1000 of the present disclosure is configured in such a manner, whereby text information conversion is able to be performed with higher accuracy.

### First Example

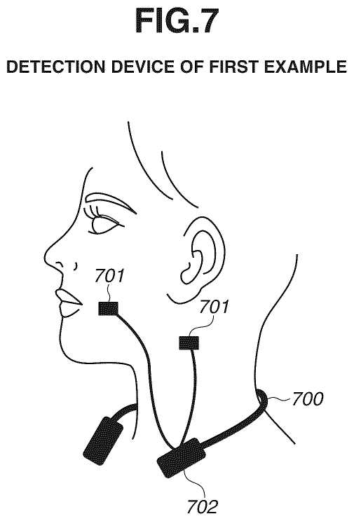

An example of the information conversion system 1000 of the present disclosure will be described with reference to FIG. 7. FIG. 7 is a schematic diagram of a detection device 700 corresponding to the detection device 100 included in the information conversion system 1000. The detection device 700 includes biological information detection units 701 and a transmission unit 702. The biological information detection units 701 include a myoelectric potential sensor and an acceleration and angular velocity sensor, and are placed in the proximity to the mouth of a user. The biological information detection units 701 are adhered to the cheek and the neck of the user with a tape or an adhesive, whereby a movement in the vicinity of the mouth can be detected.

The myoelectric potential sensor can measure a myoelectric potential of a muscle at the attachment part, and the acceleration and angular velocity sensor can measure a movement in the vicinity of the mouth as translational acceleration on three axes and angular velocity on three axes.

The sampling rates of the myoelectric potential sensor and the acceleration and angular velocity sensor are set to 2 kilohertz (kHz).

The transmission unit 702 is stored in a housing on a neck band. A myoelectric potential signal, an acceleration signal, an angular velocity signal, and a magnetic signal detected by the biological information detection units 701 are transmitted to the transmission unit 702 via wired communication and are further transmitted to the information processing apparatus 200 via wireless communication. Specifically, the wireless communication includes wireless LAN communication, such as Wi-Fi®, short-range wireless communication, such as Bluetooth®, and the like. The detection device 700 is powered by a battery (not illustrated) in the neck band. In FIG. 7, the biological information detection units 701 are configured to detect biological information at two parts on the face. That is, the biological information detection units 701 can detect biological information at a plurality of parts. The biological information may be detected at one part or at three or more parts. Further, sensors placed at respective parts in contact with the user may be different types from each other. Furthermore, biological information to be detected may be only a myoelectric potential signal or only translational acceleration on the three axes. The biological information is not limited to myoelectric potential, translational acceleration, angular velocity, and magnetism, and various types of information, such as strain, tactile sensation, and ultrasound, may also be detected.

In the present example, the information processing apparatus 200 is, for example, a smartphone, the display unit 110 is a display of the smartphone, and the audio information output unit 120 is a speaker or a wired/wireless earphone. The audio information output unit 120 may be a component of the detection device 700, and for example, the audio information output unit 120 may be a bone conduction earphone (not illustrated).

The following is a description of processing that is performed by the training unit 240 included in the information processing apparatus 200.

First, a large number of myoelectric potential signals, acceleration signals, angular velocity signals, and magnetic signals detected by the detection device 100, and text information corresponding to each signal are stored in the storage device 250 in advance.

The preprocessing unit 222 appropriately sets a frame size, a frame shift, and a window function, and converts each signal acquired from the storage device 250 into a spectrogram. For example, the frame size may be 48 (24 milliseconds), the frame shift may be 24 (12 milliseconds), and the window function may be a Hamming function. Further, the transformed spectrogram is normalized. The frame size, the frame shift, and the window function are not limited to the above. Text information acquired from the storage device 250 is converted into a character string, such as “o N g a k u s a i s e e” meaning “play music”, which may also be hiragana or the like.

In the training unit 240, training for learning weights of the model is performed using the spectrogram and the character string converted by the preprocessing unit 222 as teacher data. The architecture of the model includes a plurality of two-dimensional convolutional layers, a Bidirectional Gated Recurrent Unit (BiGRU) layer, and a linear combination layer. In a case where a plurality of spectrograms is input, a three-dimensional convolution layer may be included. The optimization function is Adaptive Moment Estimation with Weight decay (AdamW), and the loss function is CTC loss. The model architecture, the optimization function, and the loss function are not limited to these, and various functions can be used. The trained model acquired by the training unit 240 is stored in the storage device 250. The training unit 240 may be configured by a separate device, or the function may be substituted by acquiring a trained inference model.

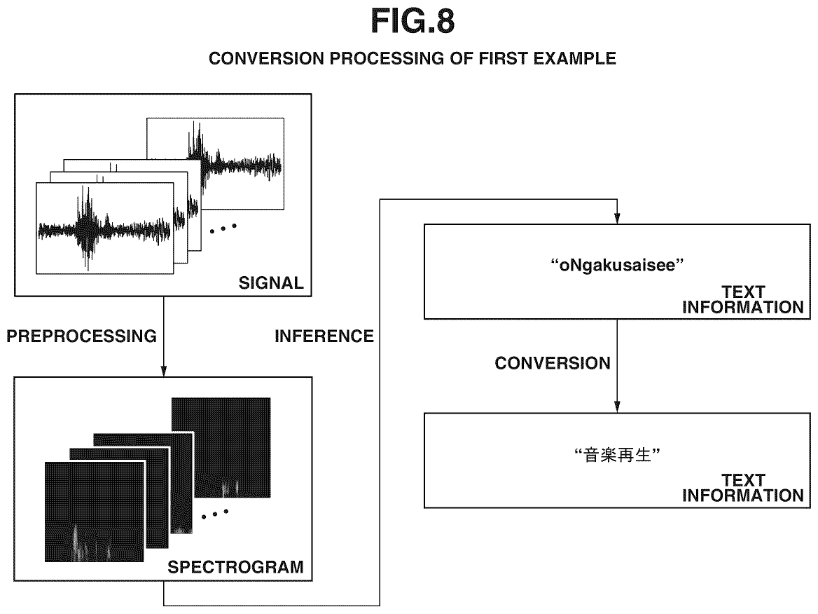

Next, with reference to FIG. 8, the following is a description of processing that is performed by the conversion unit 220 included in the information processing apparatus 200.

The myoelectric potential signal, the acceleration signal, the angular velocity signal, and the magnetic signal, which are the biological information acquired by the signal acquisition unit 221 included in the conversion unit 220, are subjected to processing similar to the processing that is performed by the preprocessing unit 222 described in the above-described embodiment, and are converted into a spectrogram which is feature matrix data. Further, the inference unit 223 inputs the spectrogram to the trained model acquired from the storage device 250 and causes the trained model to output text information corresponding to the biological information. The conversion unit 220 further converts “o N g a k u s a i s e e” into [symbol]
meaning “play music”. The converted text information is transmitted to the display unit 110 by the output unit 230. The output unit 230 may also convert the text information into audio information and transmit the audio information to the audio information output unit 120.

### [First Modification]

The preprocessing unit 222 may perform Fourier transform on each frame and acquire a plurality of Fourier spectra corresponding to the respective frames. Real parts of the plurality of acquired Fourier spectra are used as column vectors and are successively arranged in the row direction based on an acquisition time of the corresponding biological information, whereby feature matrix data is acquired. Hereinafter, the feature matrix acquired by this processing is referred to as a real part Fourier spectrogram. Similarly, by using imaginary parts of the Fourier spectrum as column vectors, feature matrix data is acquired, and this feature matrix is referred to as an imaginary part Fourier spectrogram. Alternatively, by using the absolute values of the real parts or the imaginary parts of the Fourier spectrum as column vectors, feature matrix data may be acquired. Further, a three-dimensional array obtained by superimposing the real part Fourier spectrogram and the imaginary part Fourier spectrogram is referred to as a complex Fourier spectrogram. Any of the above-described feature matrix data may be used in the processing described below, or a plurality of feature matrices may be superimposed and used as three-dimensional array data in the processing described below. Alternatively, the feature matrix may be superimposed on the above-described spectrogram and/or the like to obtain three-dimensional array data for use in the processing described below.

### [Second Modification]

A second modification of the first example of the information conversion system 1000 according to the present disclosure will be described. The redundant descriptions of those of the first example will be omitted as appropriate.

In the present modification, signal data as biological information is converted into a Mel spectrogram in the teacher data acquisition unit 231 of the training unit 240 and the preprocessing unit 222 of the conversion unit 220.

Specifically, after conversion of the signal into a power spectrum, a log-Mel filter feature is acquired by convoluting the power spectrum with a log-Mel filter. The log-Mel filter features of the respective frames are arranged as column vectors in the row direction to acquire a Mel spectrogram as feature matrix data. The acquired Mel spectrogram is transmitted to the inference model acquisition unit 232 of the training unit 240 or the inference unit 223 of the conversion unit 220. Various filters, such as a linear filter, can be used as a filter to be convoluted with the power spectrum.

### [Third Modification]

A third modification of the first example of the information conversion system 1000 according to the present disclosure will be described. The redundant descriptions of those of the first example will be omitted as appropriate.

In the present modification, the conversion unit 220 uses an inference model that infers a plurality of commands set in advance. Examples of commands include “turn on light”, “what time is it?”, “what's the weather like tomorrow?”.

The teacher data acquisition unit 231 in the training unit 240 converts signal data, which is biological information, into feature matrix data, such as a spectrogram, by the method described in the first embodiment and others. Further, text information is converted into a one-hot vector or the like corresponding to a preset command.

The model training unit 233 performs training in which weights of the model are learned using the feature matrix data and the one-hot vector as teacher data. The architecture of the model includes a plurality of two-dimensional convolutional layers and linear combination layers. The optimization function is SGD, and the loss function is Cross-entropy loss. The model architecture, the optimization function, and the loss function are not limited to these, and various functions can be used. Information on the trained model acquired by the training unit 240 is transmitted to the storage device 250.

The inference unit 223 in the conversion unit 220 uses, as an inference model, the inference model that receives the feature matrix data as an input and outputs a class corresponding to a predetermined command. The output unit 230 outputs a result of the inference by the inference unit 223 to at least one of the display unit 110 and the audio information output unit 120.

### [Fourth Modification]

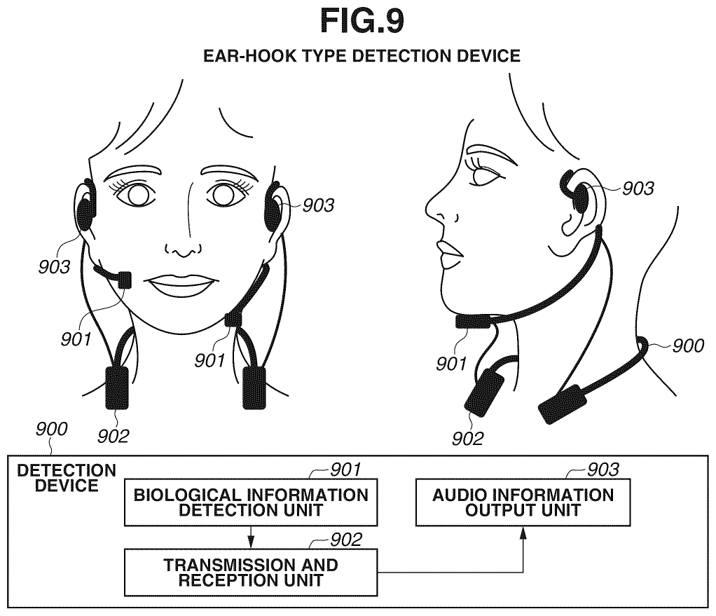

A fourth modification of the first example of the information conversion system 1000 according to the present disclosure will be described. The redundant descriptions of those of the first example are omitted as appropriate. In a detection device 900 of the present modification, biological information detection units 901 as illustrated in FIG. 9 are of an ear-hook type. The biological information detection units 901, such as a myoelectric potential sensor or an acceleration and angular velocity sensor, are fixed to support parts made of resin, for example, and are in contact with the skin of the lower jaw, the cheek, or the like of a user with an appropriate pressure. Biological information detected by the biological information detection units 901 is transmitted to a transmission and reception unit 902 in the neck band via wired communication and is further transmitted to the information processing apparatus 200 via wireless communication. A detection device 900 is powered by a battery (not illustrated) in the neck band.

In a case where the information processing apparatus 200 outputs audio information, the transmission and reception unit 902 receives the audio information, and the audio information can be reproduced by audio information output units 903, such as speakers or bone conduction earphones of an ear hook unit.

### [Fifth Modification]

A fifth modification of the first embodiment of the information conversion system 1000 according to the present disclosure will be described.

In the above-described embodiment, the conversion unit 220 converts biological information into text information by using the trained model trained by the training unit 240.

In the present modification, the training unit 240 further performs additional training of the inference model using teacher data in which ground truth that is text information based on speech information on speech motion by a user and training data that is feature matrix data acquired from the biological information are paired. In this processing, conversion from the speech information into the text information may be implemented by any of known techniques.

With the above-described configuration, training according to characteristics of the user is possible, and conversion into text information can be performed with higher accuracy than accuracy at the time of distribution.

### Other Example

The present disclosure can also be realized by processing in which a program that realizes one or more functions of the above-described embodiments is supplied to a system or an apparatus via a network or a storage medium, and one or more processors in a computer of the system or the apparatus read and execute the program. The present disclosure can also be realized by a circuit (for example, an application-specific integrated circuit (ASIC)) that realizes one or more functions. The program and a computer-readable storage medium storing the program are included in the present disclosure.

The above-described embodiments of the present disclosure are merely examples of embodiments for carrying out the present disclosure, and the technical scope of the present disclosure should not be construed as being limited by these embodiments. That is, the present disclosure can be implemented in various forms without departing from the technical idea or the main features thereof.

According to the present disclosure, an inference model for inferring feature matrix data corresponding to a plurality of syllables acquired from biological information is used to infer text information from the biological information with high accuracy.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An information conversion system comprising:
a biological information acquisition unit configured to acquire biological information based on a muscle movement caused by a speech motion of a user;
a conversion unit configured to convert the biological information into text information by using the biological information to acquire feature matrix data based on an acquisition time of the biological information and inputting the feature matrix data to an inference model to cause the inference model to infer the text information corresponding to the feature matrix data; and
an output unit configured to output the text information converted by the conversion unit.

2. The information conversion system according to claim 1, wherein the biological information is at least one of myoelectric potential information, acceleration information, angular velocity information, and magnetic information based on the speech motion of the user.

3. The information conversion system according to claim 1, wherein the biological information is information that does not include speech information on the speech motion of the user.

4. The information conversion system according to claim 1, wherein the biological information includes two or more types of information acquired from one part of the user.

5. The information conversion system according to claim 1, wherein the biological information includes two or more types of information acquired from a plurality of parts of the user.

6. The information conversion system according to claim 1, wherein the feature matrix data is a spectrogram.

7. The information conversion system according to claim 6, wherein the feature matrix data is the spectrogram generated by acquiring a plurality of power spectra based on the biological information and successively arranging the plurality of power spectra according to the acquisition time of corresponding biological information.

8. The information conversion system according to claim 1, wherein the feature matrix data is a complex Fourier spectrogram.

9. The information conversion system according to claim 1, wherein the feature matrix data is a Mel spectrogram.

10. The information conversion system according to claim 1, wherein the inference model is an inference model trained using, as teacher data, the feature matrix data based on the acquisition time of the biological information acquired by using the biological information based on the muscle movement caused by the speech motion of the user and the text information based on the speech motion of the user.

11. The information conversion system according to claim 1, further comprising a display unit configured to display an output by the output unit,
wherein the display unit displays the text information.

12. The information conversion system according to claim 1, further comprising a training unit configured to perform additional training of the inference model by using teacher data in which the text information based on the speech motion of the user is set as ground truth and the feature matrix data acquired from the biological information based on the muscle movement caused by the speech motion of the user is set as training data.

13. The information conversion system according to claim 1,
wherein the conversion unit has a plurality of inference models each trained by different training data, and
wherein the inference is performed using an inference model selected from among the plurality of inference models.

14. The information conversion system according to claim 13, further comprising:
a speech information acquisition unit configured to acquire speech information on the speech motion of the user,
wherein an inference model in which a matching rate between a plurality of inference results obtained by inputting the feature matrix data acquired from the biological information based on the muscle movement caused by the speech motion of the user to the plurality of inference models and the speech information satisfies a predetermined condition is selected.

15. The information conversion system according to claim 1, wherein the inference model is a neural network including a convolutional layer.

16. An information processing apparatus comprising:
a teacher data acquisition unit configured to acquire teacher data including feature matrix data based on an acquisition time of biological information and text information corresponding to the biological information, the feature matrix data being acquired using the biological information based on a muscle movement caused by a speech motion of a user;
an inference model acquisition unit configured to acquire an inference model; and
a training unit configured to train the inference model by using the teacher data.

17. An information processing method comprising:
acquiring teacher data including feature matrix data based on an acquisition time of biological information and text information corresponding to the biological information, the feature matrix data being acquired using the biological information based on a muscle movement caused by a speech motion of a user;
acquiring an inference model; and
training the inference model by using the teacher data.

18. An information conversion method comprising:
acquiring biological information based on a muscle movement caused by a speech motion of a user;
converting the biological information into text information by using the biological information to acquire feature matrix data based on an acquisition time of the biological information and inputting the feature matrix data to an inference model to cause the inference model to infer the text information corresponding to the feature matrix data; and
outputting the text information converted by the converting.

19. A non-transitory computer-readable storage medium storing a program for executing the information conversion method according to claim 18 on a computer.
